(19) United States
(12) Patent Application Publication
(10) Pub. No.: US 2005/0225982 A1
(43) Pub. Date: Oct. 13, 2005

(54) Crown molding with lighting effects

(76) Inventor: Richard Hahn, Pamona, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 11/149,589

(22) Filed: Jun. 11, 2005

Related U.S. Application Data
(63) Continuation-in-part of application No. 10/359,381, filed on Feb. 5, 2003, now abandoned.

(51) Int. Cl. F21S 8/00

(52) U.S. Cl. 362/252

(57) ABSTRACT

A crown molding has a vertically oriented mounting leg joined with an outwardly angled decorative leg in a modified “V” configuration. A plurality of spaced apart webs are each extensive between the mounting leg and the decorative leg. Each of the webs provides at least one concave groove on an upwardly directed top edge, thereby forming a plurality of such grooves in longitudinally spaced apart positions. A flexible lighting tube is engaged within the grooves and extensive longitudinally. Apertures are placed in the decorative leg to allow light from the lighting tube to filter downwardly.

### RELATED APPLICATIONS

This application is a Continuation In Part Application of a prior filed application having Ser. No. 10/359,381 and filing date of Feb. 5, 2003 and entitled: Wall Molding Mounting Structure And Method and is related to Ser. No. 10/810,936 filed on Mar. 26, 2004.

### BACKGROUND

1. Field of the Present Disclosure

This disclosure relates generally to indirect lighting systems for rooms and also to crown molding structures for improving the appearance of interior spaces, and more particularly to a crown molding system with indirect lighting features.

2. Description of Related Art

The following art defines the present state of this field and each U.S. disclosure is hereby incorporated herein by reference:

Richter, U.S. Pat. No. 1,249,500 describes the combination of interior illumination with the walls of a room, of a removably light confining trough involving a supporting body structure designed to contact with and be securely fastened to the said walls, the lower portion of said body having provided with a ledge; suitable brace members secured to said body above the ledge; a radially disposed member consisting the exposed wall of the trough, which radial member is supported by the said brace members and aforesaid ledge; and lighting means concealed from view with the trough.

Goodhouse, U.S. Pat. No. 1,780,125 describes a fixture for indirect illumination, a moulding strip including a fixed section constituting a supporting and reflecting means for the source of illumination and a movable section for protecting and concealing the source of illumination and interengageable means of connection provided respectively on said sections, said fixed section having a strenghening flange projecting outwardly therefrom and disposed at an angle with an outer portion of the movable section with which it engages for strengthening and supporting purposes.

Beck, U.S. Pat. No. 2,428,827, discloses an illuminating block, having a base, comprising a pair of lateral walls forming a right dihedral angle and a pair of sector-shaped end walls at right angles thereto, a centrally cusped duplex concave reflector extending within the dihedral angle near the outer part thereof, a pair of tubular lamps in the respective concavities of the duplex reflector and carried by the sector-shaped end walls, an outwardly convex centrally cusped duplex light-diffusing face plate spanning the area between the forward edges of said base, and bolts extending through the vertex of the dihedral angle and the cusps of the reflector and fact plate for maintaining the parts in assembled relation.

Eschelbach et al., U.S. Pat. No. 2,922,029, discloses a pair of longitudinally extending upstanding cornice boards disposed at right angles to one another, one of which faces each of a pair of adjacent walls, each of the cornice boards having its lowermost edge positioned closer to the walls than its uppermost edge, whereby the boards are positioned at an angle between about 10″ and 20″ to the vertical of the walls, cornice board connecting means for connecting adjacent ends of said cornice boards.

Roberts, U.S. Pat. No. 4,600,975 describes an indirect lighting assembly consisting of a housing structure and low voltage light tubing for retention therein, said housing structure being a unitarily extruded body having an anchor tab portion extending perpendicularly into a spacer portion and terminating in a light tube housing portion having an open area directing light generally perpendicular to the plane of said spacer portion.

Bourdon, U.S. Pat. No. 4,725,931, discloses a cove fixture described herein that is formed of an extruded elongated trough body having a series of grooves on the inner face of its side walls, an additional wall extends upwardly from within the body and includes also a groove longitudinally thereof. A fluorescent supporting plate is slidably mounted in the grooves so that one or more fluorescent lamp may be longitudinally adjusted in the body to provide optimum light distribution over the wall of a room where the light fixture is mounted.

Kanarek, U.S. Pat. No. 5,226,724 describes a modular, fluorescent, indirect lighting system which may be easily mounted to most surfaces by the user, without any technical knowledge or experience, using just a screwdriver and measuring tape. The system is comprised of a family of plug-in modules, each of which contain an integral power bus, that provides power continuity to the adjacent module, and a gender conversion plug that allows the installer to configure each module so that power is supplied only from female connectors. The system includes a power source module and three sizes of illumination modules, which house single 20, 30 or 40 watt lamps, as well as inside and outside corner modules and both straight and corner adjustable-length modules. Modules selected from this family can be plugged together to create a cove lighting system for a room of almost any size or shape. The complete installation is powered by a neat line cord plugged into a standard wall outlet. And, each module can accommodate a continuous decorative facing strip that both enhances the appearance and conceals the modular nature of the system.

Brooks, U.S. Pat. No. 5,823,655 describes a decorative lighting trim system comprising an assemblage of architectural moldings having a viewable surface which is structured to simulate an architectural trim or molding. The architectural molding is configured to retain lights, and to retain and conceal interconnecting electrical wiring to electrify the lights, in a manner which permits the attachment of the architectural moldings to a building surface. Because the architectural moldings are constructed to appear like conventional trims or moldings, the lighting system is virtually inconspicuous when attached to a house, building or other architectural structure, such as a fence or garage. The architectural moldings are in modular sections having varying selected lengths which allow the user to select the appropriate number and length of modular sections to extend along a given building surface, such as an eave, gable or window. The modular architectural molding assemblage is designed to be affixed relatively permanently to a building to eliminate the need for yearly seasonal hanging of lighting trim.

Fimbres, U.S. Pat. No. 5,908,179, discloses a special connector for use with a drapery headrail that incorporates an attachment clamp for flexible tubular lighting devices at one end of the connector. At the opposite end the connector incorporated a protuberance or some other structure for removably interacting with the headrail (i.e., the protuberance snaps into a channel or groove on the head rail). The connector may also incorporate a clamp to grasp a valance and thus act as an improved valance clip which is removably attachable to the drapery headrail and to the valance and also incorporates a device to hold a length of flexible tube accent lighting. The clips may be readily rearranged on the head rail to prevent drooping of the flexible tube or to create complex patterns with the tube. The flexible tube may be readily removed for replacement of defective elements. Clips can be available in different configurations so that the accent lighting is most prominent on the valance, most prominent on the drapery or is even aimed upwards towards the ceiling. Modified head rails may incorporate a channel that acts as a clamp to hold the tubular accent lighting.

Grossman et al., U.S. Pat. No. 6,454,431, discloses a modular cove lighting system that is formed of tubular fluorescent light fixtures connected together in parallel. The modular system is capable of providing uniform illumination along its length. The modular system advantageously may include straight lamps, curved lamps (including lamps forming 90.degree. angles), and/or hinged lamp fixtures. The system may be constructed with lamps that are illuminated completely from end to end, which can then be lined up end-to-end to create the illusion of one continuous lamp. Through special matching of ballasts and appropriate lamps, the lamps will dim evenly with each other, regardless of the lengths and shapes of the lamps. Each lamp and ballast is completely contained in a casing to form a cove lighting module. Multicolor systems formed of one or more light fixtures are also disclosed. A recessed light fixture is also disclosed.

Cini, U.S. Pat. No. 6,736,522, discloses a elongate light fixture, the light fixture having an adjustable overall length, and a method of installing same. The elongate light fixture includes a first piece that includes a first reflector shroud portion and a second piece that includes a second reflector shroud portion. The first and second pieces are coupled to a frame to permit relative movement of the first and second pieces for spacing the first and second pieces at a desired distance apart to provide the desired overall length of the housing arrangement and to provide a space between the first and second pieces. The adjustable-length, elongate light fixture further includes an insert that is trimmable to fit in the space between the first and second pieces. The method of installing an adjustable-length, elongate light fixture, the method including moving a first piece, which includes a first reflector shroud, of a housing arrangement relative to a second piece, which includes a second reflector shroud, of the housing arrangement. The step of moving includes moving the first and second pieces relative to each other and spacing the first and second pieces at a desired distance apart to provide the desired overall length of the housing arrangement. The method further includes trimming an insert to fit in the space between the first and second pieces, and securing the trimmed insert into the space.

Our prior art search with abstracts described above teaches indirect lighting systems and crown moldings that are formed of various materials and which have lighting devices mounted in or on them. Thus, the prior art shows lighting mounted in moldings usually in long wall fixtures using tubular lamps. However, the prior art fails to teach a decorative crown molding system using long lighting elements mounted in grooves formed in spaced apart integrally molded-in webs. The prior art also fails to teach such a crown molding product with arrays of slots of a size, placement, and density as to provide significant light effects directed downwardly and to provide sufficient cooling of air movement upward and around the lighting fixtures. The present disclosure provides these improvements distinguishing over the prior art and thus provides heretofore unknown advantages as described in the following summary.

### SUMMARY

This disclosure teaches certain benefits in construction and use which give rise to the objectives described below.

A crown molding system has a vertically oriented mounting leg joined with an outwardly angled decorative leg in a modified “V” configuration. Long segments of such units may be mounted in a room end to end to form a continuous crown molding. A plurality of spaced apart webs are each extensive between the mounting leg and the decorative leg of each of the units that make up the system. Each of the webs provides at least one concave groove on an upwardly directed top edge, thereby forming a plurality of such grooves in longitudinally spaced apart positions. A flexible lighting tube is engaged within the grooves and extensive longitudinally. Apertures are placed in the decorative leg to allow light from the lighting tube to filter downwardly from the crown molding and to allow cooling air to flow upwardly through the molding and over the lighting tube.

A primary objective inherent in the above described apparatus and method of use is to provide advantages not taught by the prior art.

Another objective is to provide a lighting effect in a crown molding.

A further objective is to provide a combination crown molding and indirect light fixture.

A still further objective is to provide a crown molding element with an integral molded light tube support.

A still further objective is to provide for water drainage from the molding.

A still further objective is to provide a means for projecting a lighting effect from the crown molding.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view of a first embodiment of the present apparatus shown with spaced-apart web elements and a tubular lighting fixture;

FIG. 2 is a sectional view thereof taken along line 2-2 in FIG. 1;

FIG. 3 is a perspective view of a second embodiment of the present apparatus shown with spaced-apart web elements and two tubular lighting fixtures; and

FIG. 4 is a sectional view thereof taken along line 4-4 in FIG. 3.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

The present crown molding apparatus provides a vertically oriented mounting leg 10 joined with an outwardly angled decorative leg 20 in a modified “V” configuration, as shown in FIGS. 2 and 4. A plurality of spaced apart webs 30 are preferably oriented normal to the mounting and decorative legs and extensive between them. Preferably, the webs 30 are molded integrally with the legs 10 and 20, although they may be formed separately and fastened inside the crown molding after it is formed. Each of the webs 30 provides at least one concave groove 32 on an upwardly directed top edge 34 thereof, thereby forming a plurality of such grooves 32 in longitudinally spaced apart positions in the crown molding. A lighting tube 40 is positioned within the grooves 32 in such a position that it cannot normally be seen from a floor in the room where the crown molding is installed, i.e., it is masked by the decorative leg 20, as shown in FIGS. 2 and 4. Preferably, the lighting tube 40 is of the type utilizing a clear plastic tube 42 with a string of lamps 44 within the plastic tube 42. Such plastic tubes 42 are quite compliant, deformable and bendable so as to be easily inserted into the grooves 40 and to be easily bent for turning a corner in such a crown molding installation.

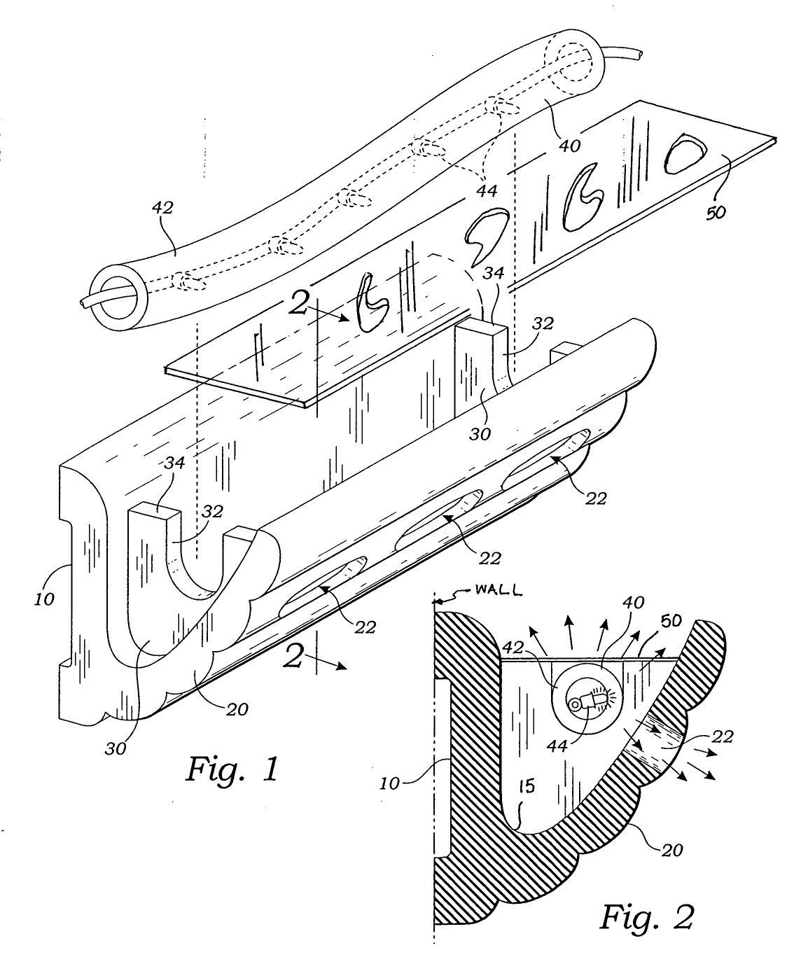

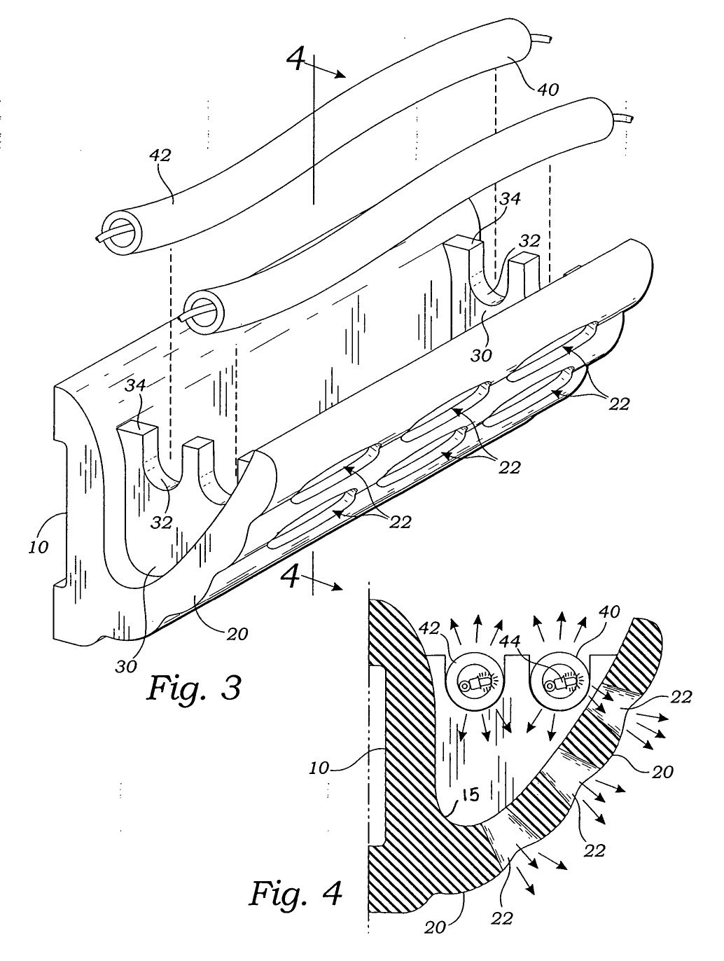

Preferably, the decorative leg 20 provides apertures 22 therein in longitudinally spaced apart positions, as shown in FIGS. 1 and 3, such that light from the lighting tube 40 is able to pass through the apertures 22 for being directed downwardly. In the figures, the apertures 22 are shown to be elongate in shape, but those of skill in the art will routinely substitute other shapes such as a star shape, a triangle shape, a heart shape and so forth.

Preferably, the apertures 22 form a single longitudinally aligned aperture array as shown in FIG. 1, but may also form a plurality of longitudinally aligned aperture arrays, as shown in FIG. 3. Preferably, at least one array of the apertures is positioned, as shown in FIG. 4, so that moisture collected within the apparatus is able to drip through the apertures so that the apparatus cannot become filled with water.

Preferably, the grooves 32 are of such size as to engage the lighting tube 40 in compressive gripping action when the lighting tube 40 is pushed into the grooves 32.

Preferably, each of the webs 30 provides one of the grooves 32, as shown in FIGS. 1 and 2, but they may provide plural concave grooves 32, as shown in FIGS. 3 and 4.

In one embodiment, the decorative leg 20 is of a translucent plastic material, such as polycarbonate, so as to be fully illuminated by the lighting tube 40. In a further embodiment of the present apparatus, the decorative leg 20 may be fully transparent so as to allow maximum transmission of light from the lighting tube 40 to propagate downwardly.

In an alternate embodiment, an interior surface 15 of the mounting 10 and decorative 02 legs is at least partially parabolic in shape and of a reflective character so as to project light upwardly. This surface 15 may be coated with a reflective paint or other coating, or an insert (not shown) may be placed into intimate contact with the legs 10 and 20 to form surface 15.

In the embodiments described above, the interior surface 15 and/or the lighting tube 40 may be colored so as to emit and reflect a selected light color.

As shown in FIG. 2, a solid decorative insert 50 may be positioned and secured over the lighting tube, the decorative insert 50 providing a transparent pattern enabling projection of the pattern upwardly. The insert 50 may be formed as a die cut thin sheet or it may be printed onto a thin transparent plastic sheet, etc. The die cut version is considered superior at it allows air flow to rise through the insert 50 for cooling the lighting tube 40.

In a still further embodiment of the present disclosure, the surface 15, especially on decorative leg 20 may be coated with a decorative pattern, or alternately receive and support the solid decorative insert 50 so as to project the pattern downwardly.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. A crown molding apparatus comprising: a vertically oriented mounting leg joined with an outwardly angled decorative leg in a modified “V” configuration; a plurality of spaced apart webs extensive between the mounting leg and the decorative leg, each of the webs providing at least one concave groove on an upwardly directed top edge thereof, thereby forming a plurality of such grooves in longitudinally spaced apart positions; and a lighting tube positioned securely within the grooves.

2. The apparatus of claim 1 wherein the decorative leg provides apertures therein in longitudinally spaced apart positions such that light from the lighting tube is able to pass through the apertures for being directed downwardly.

3. The apparatus of claim 2 wherein the apertures form at least one longitudinally aligned aperture array.

4. The apparatus of claim 1 wherein the lighting tube is of a compliant material, the grooves of such size as to engage the lighting tube in compressive gripping action when the lighting tube is pushed into the grooves.

5. The apparatus of claim 1 wherein each of the webs provides at least one concave groove therein.

6. The apparatus of claim 1 wherein the mounting leg, the decorative leg and the webs are molded integrally.

7. The apparatus of claim 1 wherein the decorative leg is of a material of one of: translucent and transparent plastic, for directing light from the lighting tube therethrough.

8. The apparatus of claim 1 wherein an interior surface of the mounting and decorative legs is at least partially parabolic in shape; the interior surface further characterized as reflective, so as to project light upwardly.

9. The apparatus of claim 8 wherein at least one of the interior surface and the lighting tube is colored so as to emit and reflect a selected light color.

10. The apparatus of claim 1 further comprising a solid decorative insert position over the lighting tube, the decorative insert providing a transparent pattern enabling projection of the pattern upwardly.

11. The apparatus of claim 7 further comprising a decorative pattern positioned on the decorative leg, the decorative pattern at least partially transparent and thereby providing projection of the decorative pattern downwardly.
